(19) United States
(12) Patent Application Publication
(10) Pub. No.: US 2007/0214419 A1
(43) Pub. Date: Sep. 13, 2007

(54) Integrated service creation and execution platforms for the converged networks

(76) Inventors: Ashish Jain, Bridgewater, NJ (US); Devasis Bassu, Flanders, NJ (US); Hira Agrawal, Bridgewater, NJ (US); Saul London, Highland Park, NJ (US); Christopher Lott, Morristown, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/712,772

(22) Filed: Mar. 1, 2007

Related U.S. Application Data
(60) Provisional application No. 60/778,027, filed on Mar. 1, 2006.

(51) Int. Cl. G06F 15/177

(52) U.S. Cl. 715/736

(57) ABSTRACT

A service creation and execution platform provides a unified representation for messages and network protocols. Specifically, the platform is flexible and relies on a bootstrapping approach which enables incorporation of new message formats and protocols. Additional capabilities of the platform include a Graphical User Interface which makes specification of network services easier.

### CROSS-REFERENCE TO RELATED APPLICATIONS

This application claims the benefit of the filing date of U.S. Provisional Patent Application No. 60/778,027, filed Mar. 1, 2006, the disclosure of which is hereby incorporated herein by reference.

### FIELD OF THE INVENTION

The present invention concerns a service creation and execution platform which provides a unified representation for messages and network protocols. Specifically, the platform is flexible and relies on a bootstrapping approach which enables incorporation of new message formats and protocols. Additional capabilities of the platform include a Graphical User Interface which makes specification of network services easier.

### BACKGROUND OF THE INVENTION

Creating network services offerings for customers which include video, voice, and data require working with several networks which uses different messaging formats and protocols. Using present day platforms for creation of converged services is difficult because the service developer not only needs a deep understanding of the programming languages, but also a deep understanding of messaging and networking protocols. The present invention is a service creation and execution platform which provides a unified representation for all the messages and the protocols so that the developer can focus on the core task of programming the service logic using this unified representation. A hallmark of the platform is the flexibility and the bootstrapping approach which enables incorporation of new message formats and protocols easily. Additional capabilities of the platform include a Graphical User Interface which makes specification of these services easier. Service specified using the graphical editor is stored in a structured format and the executable code for the service is generated from the structured representation.

Traditional approach to develop network services is development of a computer program which manipulates incoming messages, and in the process of execution, may send out one or more outgoing messages to other systems. Correlating response messages is part of the programming instructions specified by the developer. Thus, after the initialization of a program, the program is either executing instructions or has sent one or more request messages and is waiting for response message(s). The “wait” state is generic and the burden is on the programmer to specify, using programming instructions, logic to distinguish response messages so that appropriate message handling logic can be applied. This is the typical service execution model currently available, and the examples include, standard Java callback/listener-based (JSR-32), Java Servlet-based (JSR-116) for SIP programming and execution environments which deal with SIP (session initiation protocol) message formats.

### SUMMARY OF THE INVENTION

The present invention differs from the traditional approaches in two ways. First, system of the present invention allows for creation of execution logic which correlates requests and responses for arbitrary message formats (HTTP, SIP, DIAMETER, SOAP, GDI, TCAP, etc). Second, the system achieves the effect of having a unique “wait” state with each pending request message. This arrangement frees the programmer from developing her own correlation logic to match a request to a response. Instead, she composes a request messages and associates a ‘callback’ with each pending request. A callback is the logic which is executed when a response corresponding to that particular request arrives. The runtime environment is built on top of traditional execution environments such as Java Servlets. Details of how the service is specified, how it is translated into the runtime code, and how the runtime code uses traditional runtime environments is at the core of the invention.

Corresponding to the three core aspects of the invention are three core components, and the invention can be best understood in terms of these components. The first component is a Graphical User Interface which allows developers to develop new services. The second component is a Runtime Engine which is a layer built on top of traditional runtime environments (one embodiment uses Java Servlet Runtime Environment). The third component is a Code Generator which takes the service specifications developed using GUI and generates the runtime code which the runtime engine executes during execution.

The invention will be more clearly understood when the following description is read in conjunction with the accompanying drawings.

### BRIEF DESCRIPTION OF THE DRAWINGS

FIG. 1 is a schematic diagram of the interrelationship of the three core components of the present invention.

FIG. 2 shows a graphical interface for service creation.

FIG. 3 is a UML class diagram for a flow (application logic building block).

### DETAILED DESCRIPTION

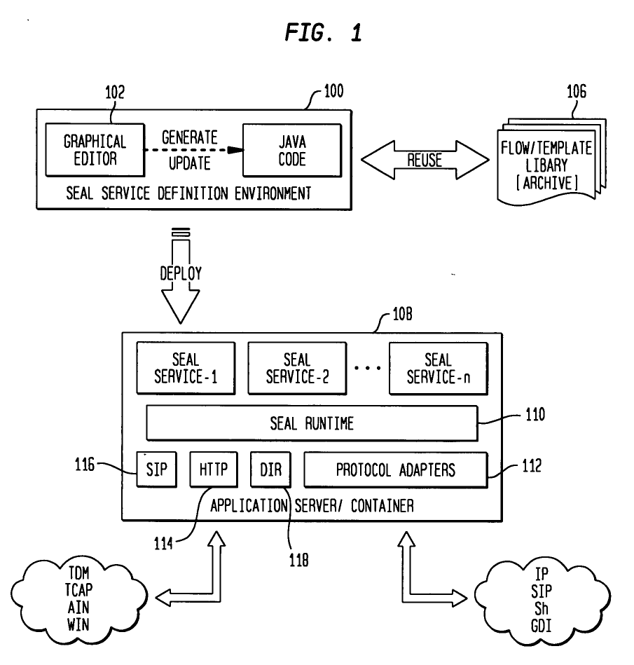

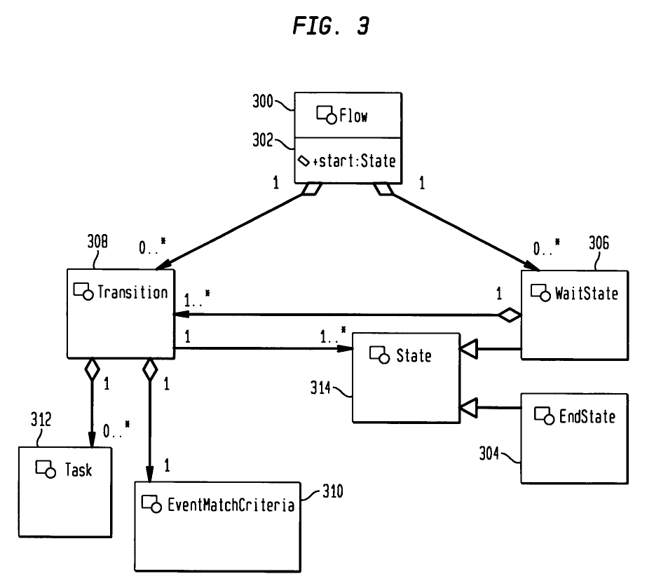

The entire service creation and execution platform is henceforth referred to as the Services and Applications Enabling Layer (SEAL). Referring now to the figures and to FIG. 1 in particular, there is shown a schematic diagram of the interrelationship of the three core components of the present invention. Application logic within SEAL is represented as SEAL flow(s). A SEAL flow (or simply flow) is a collection of one or more transitions and zero or more wait states (see FIG. 3). A transition comprises an event matching criteria and an action. An action consists of zero or more tasks. A task may be a sequence of ordinary program statements (manipulation of program variables), creation and sending of request messages, or use of FlowMessages to invoke another client callable flow. A client callable flow (a SEAL flow invoked using a FlowMessage) is a building block which is also specified using the GUI, but is made available as a reusable routine to all the service developers. A client callable flow has one or more input FlowMessages and zero of more output FlowMessages. The mechanism for delegating service processing to client flows using a protocol called FlowProtocol is described below as part of the Runtime Engine description.

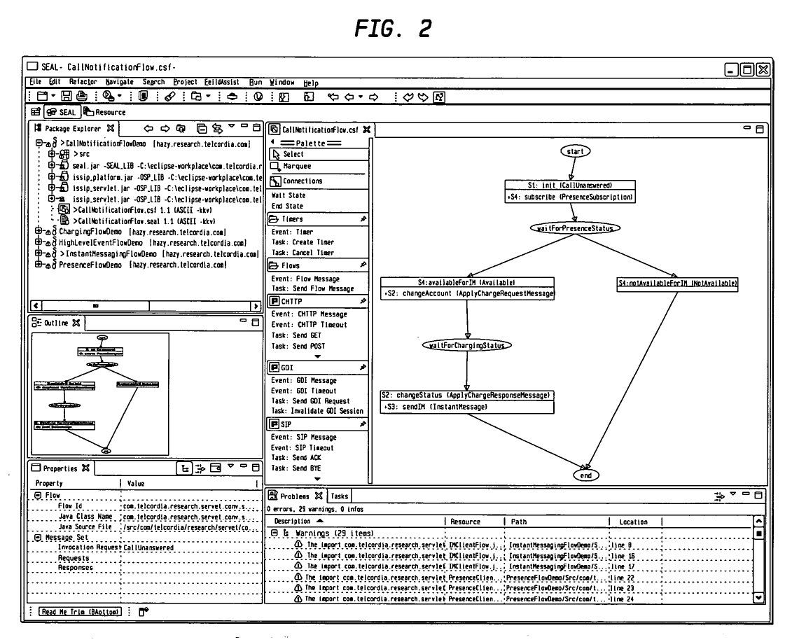

1. SEAL Graphical Front End (SEAL-GUI) 100 for creating services. A graphical user interface graphical editor 102 facilitates service development. Using the Graphical Front End, a user specifies the flow corresponding to the service logic. FIG. 2 shows a flow specified using the SEAL-GUI.

The SEAL-GUI has several innovative features. It provides a unifying way for the user to specify specification of request messages as part of the service specification task. Also, it keeps a data structure comprising all the client callable flows available to the service developer 106. Thus, when a user has to select a task, GUI controls automatically provides a list that includes all the client callable flows. When a user selects a client callable flow, GUI windows help the user with the creation and specification of the corresponding Input FlowMessage. As new client callable flows are added to the workspace, the data structure gets automatically updated. One embodiment uses the Eclipse framework to achieve the update feature. The GUI also keeps a list of all the tasks which either sent a request message or invoked a client callable flow. A program enters a wait state after executing a list of tasks, and another data structure maintains a list of pending events possible for any wait state. Thus, based upon the context (a particular wait state), the GUI provides a drop down list of pending events for the service developer to use to complete the service logic specification. Such context sensitive editing helps in developing syntactically correct service specifications.

2. SEAL Runtime Engine (SEAL-RE) is the runtime engine which is built on top of the traditional Java Servlet engine. SEAL-RE execution 110 of a flow involves repeated detection of a matching event and invocation of the appropriate transition action. As indicated, invocation of a transition means execution of the all the tasks and entering a new wait state (or end state). Flow execution terminates when invocation of a transition results in the “end” state. Execution of a service comprises creation of an application instance called application session. Within each application session, several protocol sessions are created and destroyed for the purpose of sending and receiving messages. Within a protocol session several messages are being exchanged. Correlating request—responses and tying them to appropriate application session is the core task of SEAL-RE.

SEAL-RE Flow Execution

At runtime, a flow definition is executed via a flow instance. A flow instance has a reference to the flow definition and the current state of the flow. This may be the initial start state (if flow execution has not yet started), or a wait-state, or the end state. Note that there may be multiple flow instances for any given flow definition at the same time.

Typically, a single execution of any service is represented as an application session. Various transactions (e.g., protocol-based, timers, etc.) within the application session are represented as contained protocol sessions, timer sessions, etc. Each such session is mapped to exactly one flow instance in the SEAL-RE. This mapping may change during the lifetime of the application session—however, it must always be one-to-one.

An application session/service instance is started when one of the initial conditions for the service is met. For the SEAL-RE, this results in the creation of a flow instance for the primary flow. The primary flow is a special flow definition that is associated with a service capable of handling the initial event(s) that trigger the service.

SEAL-RE Event Matching

For each incoming message from the external network as delegated by the container 108,

1. get parent application session and protocol session (if applicable) of the incoming message;

2. map incoming message to flow instance which is mapped to that protocol session (in the case that the protocol session is unavailable, the primary flow instance is used);

3. retrieve current wait state for the flow instance;

4. check incoming message against all the event match criteria of the related transitions for that wait-state; and

5. execute the action part of the transition upon match.

Service developer uses a unified representation for messages and events. Messages need to be translated into appropriate message format before they can be sent over the network. In order for SEAL-RE 110 to translate a request message from its unified representation into the requisite message format and translate a response message from a specific format to the unified format, it uses protocol adaptors 112. There are protocol adaptors, for example, HTTP 114, SIP 116, DIAMETER 118, and the like.

SEAL-RE Flow Invocation

SEAL-RE also uses a novel approach to invoke reusable flows (client callable flows) which have been earlier specified and included in a library. For performance reasons, SEAL-RE uses a data structure called FlowMessage and a special protocol called FlowMessageProtocol to delegate execution to a client callable flow.

A service instance is associated with the execution of an instance of the primary flow. The SEAL-RE provides functionality for other flows to be invoked from any given flow. This allows the service developer to modularize the service logic as opposed to having to specify it in a single flow. Further, it also permits the invoking flow and the invoked flow to exchange messages and optionally transfer protocol sessions. Note that a protocol session is mapped to exactly one flow instance. This transfer mechanism allows the service developer to handover the protocol session to various flows for specialized processing at runtime.

The SEAL-RE uses a simple asynchronous messaging scheme to achieve this. Another immediate benefit of this messaging scheme is the notion of high-level events. Consider two flows A and B established in a flow messaging session. A message sent from A to B is treated just like any other network protocol message—essentially, B can trap this message by specifying a flow event match criteria as part of a transition. Flow A could be performing complicated transactions on a protocol session and reporting back consolidated high level information back to flow B via flow messages. These may then be used by flow B as high-level events to trigger further processing.

The invocation of flow B from flow A is also achieved using the same FlowMessageProtocol. In this case, a special type of FlowMessage—a FlowlnvocationMessage is used. Flow A constructs a FlowlnvocationMessage for flow B and then sends it. This results in the creation of a flow instance of flow B that is initialized using the flow invocation message. A flow session is now established between the two flows. This session may be used for exchanging subsequent flow messages.

Note that a flow instance may be associated with more than one flow session at any time, i.e., a flow may invoke one or more other flows.

3. SEAL Code Generation (SEAL-CG) The SEAL-GUI is used to specify the flows. SEAL-RE, however, is execution code (Java Servlet code in one embodiment). The translation of SEAL flow specification into SEAL-RE code which SEAL-RE executes is achieved via the SEAL-CG. For one embodiment, the following Java classes are used to create SEAL-RE instances.

FIG. 3 shows the notation and hierarchy between the SEAL concepts via a UML class diagram. Service and application logic is defined in terms of a flow 300. A flow is initialized using the “start” method 302. This determines the initial state of the flow. This may be the end state 304 (for a trivial flow) or a wait state 306. A wait state signifies that the flow has finished processing for the time being and is waiting for some external event to take place to resume processing. A wait state comprises one or more transitions 308. A transition comprises two parts—an event match criteria 310 and an action consisting of a set of tasks 312. When an external event takes place (e.g., incoming protocol message), the event match criteria for all the transitions associated with the current wait state are evaluated. Upon a successful match, the action (tasks) part of the corresponding transition is executed. Execution of an action returns the next state 314 of the flow. Flow execution is terminated upon entering an end state 304.

The present system does in-situ generation of code as the user is specifying service flow using the GUI. Thus, a user can go back-and-forth between the graphical front-end and the code view of the service.

While there has been described and illustrated integrated service creation and execution platforms for the converged networks, it will be apparent to those skilled in the art that variations and modifications are possible without deviating from the broad teachings and principles of the present invention which shall be limited solely by the scope of the claims appended hereto.

What is claimed is:

1. A method of providing a unified representation for messages and network protocols comprising the steps of:
starting a message flow in a start state;
initializing the message flow for determining the next state of the flow which next state is either an end state or a wait state comprising one or more transitions where each transition further comprises an event match criteria and a task;
evaluating the event match criteria for all transitions associated with the current wait state upon the occurrence of an external event;
executing a transition task upon a successful event match criteria;
returning to the next state after the transition task is executed; and
repeating the steps until the next state is an end state.
